(19) United States
(12) Patent Application Publication
(10) Pub. No.: US 2009/0177619 A1
(43) Pub. Date: Jul. 9, 2009

(54) INFORMATION PROVIDING APPARATUS AND INPUT INFORMATION RECEIVING METHOD

(75) Inventors: Hirohisa Naito, Kawasaki (JP); Akira Miyazaki, Kawasaki (JP); Takahiro Kii, Kawasaki (JP); Kazumi Kubota, Kawasaki (JP); Akira Sato, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/401,446

(22) Filed: Mar. 10, 2009

Related U.S. Application Data
(63) Continuation of application No. PCT/JP2006/318518, filed on Sep. 19, 2006.

(51) Int. Cl. G06F 3/048; G06F 17/30

(52) U.S. Cl. 707/1; 715/780; 707/E17.009

(57) ABSTRACT

An information providing apparatus receives a user ID read by an IC card reader, and stores therein the user ID. The user inputs booking information by using an input screen that receives booking information, and then, the information providing apparatus further receives the user ID read by the IC card reader. The information providing apparatus then determines whether the received user ID matches the user ID stored therein. The information providing apparatus confirms reception of the booking information that is input by using the input screen if the user IDs are determined to match each other.

### CROSS-REFERENCE TO RELATED APPLICATION(S)

This application is a continuation of PCT international application Ser. No. PCT/JP2006/318518 filed on Sep. 19, 2006 which designates the United States, the entire contents of which are incorporated herein by reference.

### FIELD

The embodiment(s) discussed herein is (are) directed to an information providing apparatus, an input information receiving method, and an input information receiving program that receive input information regarding various information displayed on a display device from a user.

### BACKGROUND

In recent years, information providing apparatuses that can provide information of transportation means such as trains and busses, and of accommodations to users and can also receive booking of tickets and accommodations are installed in various service counters and convenience stores.

In such an information providing apparatus, user authentication is required, for example, to avoid fraudulent use and to charge a fee for booking.

Various methods for user authentication are proposed, and one of them is to use an ID card on which a user ID (identification) is recorded for user identification. In such a method, user authentication is performed by reading a user ID recorded on an ID card with a card reader or a card slot provided in the information providing apparatus (See, for example, Japanese Laid-open Patent Publication No. 09-128319 and Japanese Laid-open Patent Publication No. 2005-346354).

In recent years, a card in which a contactless IC chip is embedded (hereinafter, “IC card”) and a mobile phone in which a contactless IC chip is embedded are commonly used, and thus, user authentication can be performed by reading a user ID recorded on a contactless IC chip with a contactless IC reader (hereinafter, “IC reader”).

By using such an IC card and a mobile phone, even if the IC card remains in a wallet, the IC card can be, for example, put over a contactless IC reader and user authentication can be easily performed. The user can also avoid leaving the IC card in a card slot and forgetting to take the IC card therefrom.

When booking a ticket or an accommodation by using an information providing apparatus, however, the user is required to input predetermined information such as the date on which the ticket or the accommodation are used and the number of persons who use the ticket or the accommodation. To input the information is time consuming and requires effort if the user is required to input many items. In such cases, when to perform user authentication is an important issue.

For example, if user authentication is performed before the predetermined information is input, other users can modify the information that is input by the user and set the booking made by the user when the user stops inputting and leaves the information providing apparatus for some reasons or other. This may lead to a problem that a booking that is not intended by the user can be made by other users.

Thus, how to perform user authentication and receive input information easily and reliably has become a great challenge.

### SUMMARY

According to an aspect of an embodiment, an information providing apparatus includes a display control unit that receives 1st user identification information and stores the 1st user identification information in a storage unit, receives input information input to an input screen of a display, and receives 2nd user identification information; a user identification information comparing unit that determines whether the 2nd user identification information matches the 1st user identification information stored in the storage unit; and a user information setting unit that confirms reception of the input information if the user identification information comparing unit determines that the 2nd user identification information matches the 1st user identification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1A is a schematic for explaining an information providing apparatus according to a first embodiment;

FIG. 1B is a schematic for explaining the information providing apparatus according to the first embodiment;

FIG. 1C is a schematic for explaining the information providing apparatus according to the first embodiment;

FIG. 1D is a schematic for explaining the information providing apparatus according to the first embodiment;

FIG. 2 is a functional block diagram of the information providing apparatus according to the first embodiment;

FIG. 3 is a schematic of a specific example of information provided by the information providing apparatus according to the first embodiment;

FIG. 4 is a schematic of a specific example of information provided by the information providing apparatus that can save booking information.

FIG. 5 is a flowchart of processing procedures performed by the information providing apparatus according to the first embodiment;

FIG. 6A is a schematic for explaining an information providing apparatus according to a second embodiment;

FIG. 6B is a schematic for explaining the information providing apparatus according to the second embodiment;

FIG. 7A is a schematic of examples of an input screen of the information providing apparatus according to the second embodiment;

FIG. 7B is a schematic of examples of the input screen of the information providing apparatus according to the second embodiment;

FIG. 7C is a schematic of examples of the input screen of the information providing apparatus according to the second embodiment; and

FIG. 8 is a functional block diagram of a structure of a computer that executes an input information receiving program.

### DESCRIPTION OF EMBODIMENT(S)

Exemplary embodiments of an information providing apparatus, an input information receiving method, and an input information receiving program according to the present invention are described below in greater detail with reference to the accompanying drawings.

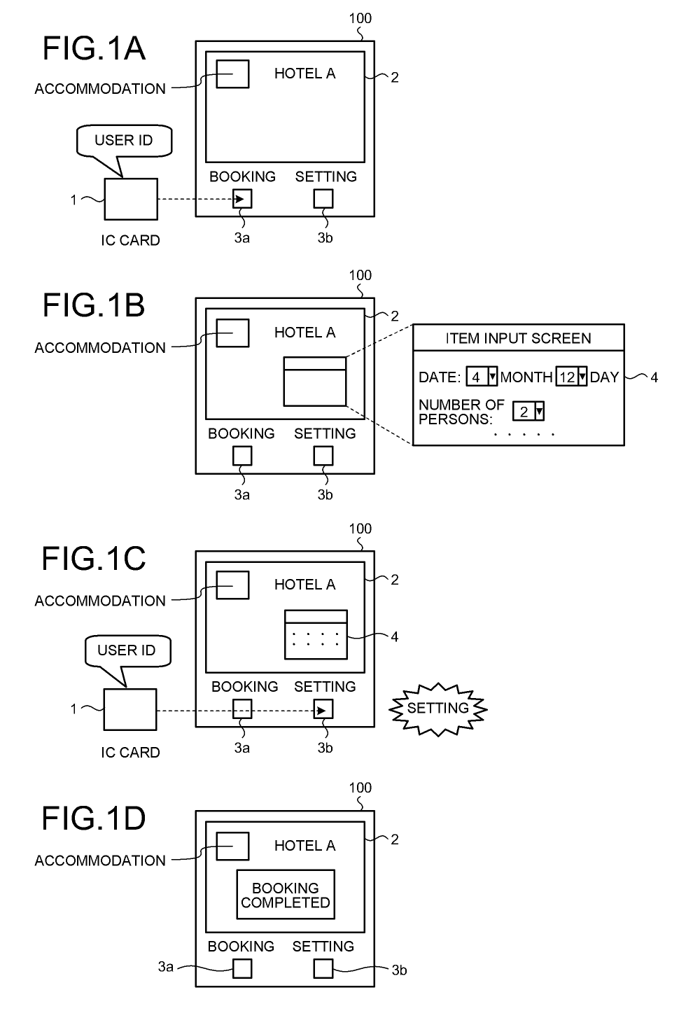

An information providing apparatus according to a first embodiment of the present invention is described below in greater detail. FIGS. 1A to 1D are schematics for explaining the information providing apparatus according to the first embodiment. An information providing apparatus 100, which is installed, for example, in a station or an air terminal, can provide information regarding accommodation facilities such as hotels and guest-houses and receive booking of accommodation facilities.

As depicted in FIGS. 1A to 1D, the information providing apparatus 100 includes a display 2 that displays information regarding accommodation facilities and IC card readers 3a and 3b that read information regarding the user from an IC card 1 in which a contactless IC chip is embedded. The user owns the IC card 1, and information such as a user ID is recorded on the IC card 1. The information providing apparatus 100 can read the user ID by using the IC card readers 3a and 3b, thereby performing user authentication.

A menu representing items “Booking” and “Setting” is displayed at a lower section of the display 2. The item “Booking” is displayed on the IC card reader 3a and the item “Setting” is displayed on the IC card reader 3b. The user can put the IC card 1 over the IC card reader 3a to input information regarding an accommodation facility in the information providing apparatus 100. The user can also put the IC card 1 over the IC card reader 3b to set or confirm the information input by the user.

It is described below in greater detail that the information providing apparatus 100 is used for, for example, booking a hotel A. When information regarding the hotel A is displayed on the display 2 of the information providing apparatus 100 and the user views the information of the hotel A and puts over the IC card reader 3a the IC card that the user owns, the information providing apparatus 100 receives the user ID of the user from the IC card 1 and stores the user ID therein (See FIG. 1A).

The information providing apparatus 100 also displays on the display 2 an input screen 4 that is used for inputting information required for booking (See FIG. 1B). When the user inputs the information required for booking (hereinafter, “booking information”) in the input screen 4 and puts the IC card 1 that the user owns over the IC card reader 3b, the information providing apparatus 100 receives the user ID of the user and determines whether the user ID stored therein matches the user ID received by the IC card reader 3b. If the user IDs match each other, the information providing apparatus 100 sets reception of the booking information input in the input screen 4 (See FIG. 1C).

The information providing apparatus 100 that determines that the booking information is received transmits the booking information input by the user to a booking management server device connected to the information providing apparatus 100 via a network, and displays on the display 2 a booking completion message that shows that the booking is completed (See FIG. 1D).

Thus, the information providing apparatus 100 according to the first embodiment receives the user ID read by the IC card reader 3a, and stores the user ID in the information providing apparatus 100. After the user inputs the booking information with the input screen that receives booking information, the information providing apparatus 100 receives the user ID read by the IC card reader 3b. The information providing apparatus 100 determines whether the thus received user ID matches the user ID stored therein. The information providing apparatus 100 is configured to set the reception of the booking information input with the input screen 4 if the user IDs are determined to match each other. Therefore, it can be avoided that the booking information input by the user is set by some other users, and as a result, input information can be received with an easy and reliable user authentication can be performed.

In the present embodiment, it is described that an IC card is used for user authentication. A device such as a mobile phone in which a contactless IC chip is embedded may, however, also be used for user authentication instead of an IC card.

In the examples depicted in FIGS. 1A to 1D, the IC card readers 3a and 3b correspond to the items “booking” and “setting” respectively. For example, the information providing apparatus 100 may, however, also be configured so that the booking information is set when the user again puts the IC card 1 over the IC card reader 3a after inputting the input information in the input screen 4. Thus, a similar function can be implemented even when there is only one IC card reader.

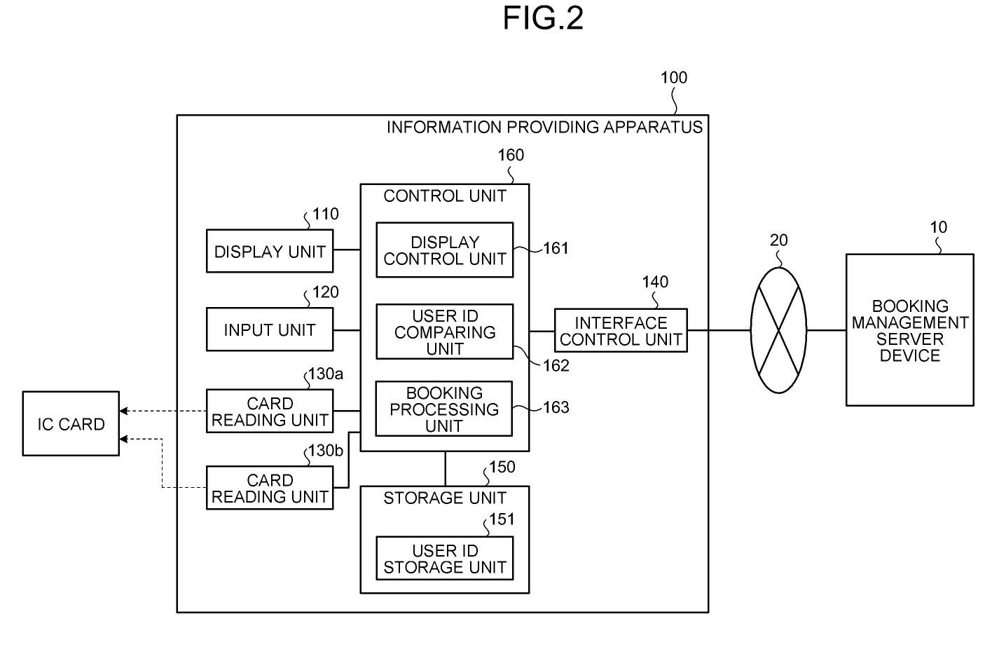

Configuration of the information providing apparatus 100 according to the first embodiment is described here in greater detail. FIG. 2 is a functional block diagram of the information providing apparatus 100 according to the first embodiment. As depicted in FIG. 2, the information providing apparatus 100 is connected via a network 20 to a booking management server device 10 that manages information such as availability of an accommodation facility, and includes a display unit 110, an input unit 120, a card reading unit 130, an interface control unit 140, a storage unit 150, and a control unit 160.

For convenience of description, only one information providing apparatus 100 is depicted in FIG. 2. A plurality of information providing apparatuses 100 are, however, installed in places such as stations and air terminals in many parts of the country, and each of the information providing apparatuses 100 is connected to the booking management server device 10 via the network 20.

The display unit 100 is a display device such as a liquid crystal display, a plasma display, and a projector, and displays information regarding an accommodation facility, the input screen 4 that is required for the user to input booking information, and the like. The input unit 120 is an input device such as a touch panel integrated into the display unit 110, and is used for inputting information such as the booking information that the user inputs with the input screen 4. The display unit 110 and the input unit 120 correspond to the display 2 depicted in FIGS. 1A to 1D.

The IC card reading units 130a and 130b are IC card readers that read various information from a contactless IC chip. The card reading units 130a and 130b correspond to the IC card reader 3a and 3b depicted in FIGS. 1A to 1D respectively. The items “Booking” and “Setting” in the menu displayed on the display unit 110 are associated with the card reading units 130a and 130b respectively.

In the present embodiment, the information providing apparatus with the two card reading units is described. However, the number of the card reading unit can be one or more than two. By modifying the menu displayed on the display unit 110 according to the number of the card reading units, various processes can be executed according to the request of the user when the IC card is read by a particular card reading unit.

The interface control unit 140 is a processing unit that controls transmission and reception of various information exchanged between the information providing apparatus 100 and the booking management server device 10. More specifically, the interface control unit 140 transmits information such as the booking information input by the user to the booking management server device 10 and receives information such as availability of an accommodation facility from the booking management server device 10.

The storage unit 150 is a storage unit that stores various information therein, and includes a user ID storage unit 151 as a component related to the present invention. The user ID storage unit 150 stores therein the user ID provided by the control unit 160 that is described later in greater detail.

The control unit 160 is a processing unit that controls the entire information providing apparatus 100, and includes a display control unit 161, a user ID comparing unit 162, and a booking processing unit 163 as components related to the present invention.

The display control unit 161 is a processing unit that controls a screen displayed on the display unit 110 and performs various processes regarding reception of booking information based on information such as the information that the user inputs via the input unit 120 and the user ID that is received via the card reading units 130a and 130b. More specifically, the display control unit 161 obtains from the booking management server device 10 various information regarding an accommodation facility according to the request of the user, and displays the information on the display unit 110.

If the display control unit 161 receives the user ID via the card reading unit 130a, the display control unit 161 stores the user ID thus received in the user ID storage unit 151 and displays on the display unit 110 the input screen 4 that is required for inputting booking information. If the user does not input any booking information for a predetermined period of time, the display control unit 161 hides the input screen 4.

Upon hiding the input screen 4, the display control unit 161 may be configured to also cancel (delete) the booking information input by the user in the input screen 4 and to notify the user whose user ID is stored in the user ID storage unit 151 that the booking information made by the user is cancelled.

The display control unit 161 receives the user ID via the card reading unit 130a after the user inputs booking information, and then, provides the received user ID to the user ID comparing unit 162 to determine whether the received user ID matches the user ID stored in the user ID storage unit 151.

If the user ID comparing unit 162 notifies the display control unit 161 that the user IDs match each other, the display control unit 161 provides to the booking processing unit 163 information that the booking information input by the user in the input screen 4 is received and deletes the user ID stored in the user ID storage unit 151 and displays on the display unit 110 a message that the booking is completed.

If the user ID comparing unit 162 notifies the display control unit 161 that the user IDs do not match each other, the display control unit 161 displays on the display unit 110 a message that the booking information is not received.

The display control unit 161 may be configured so that the input screen 4 is modified or the display position thereof is modified according to the attribute information of the user recorded in the IC card 1 (such as sex, age, height, and occupation of the user) when displaying the input screen 4. In such cases, the display control unit 161 is configured to receive the attribute information of the user along with the user ID via the card reading unit 130a. The display control unit 161 displays the input screen 4 according to the attribute information of the user. For example, the display control unit 161 does not display the input items only for men and displays a display screen that is configured to display only the input items for ladies if the user is female, and, based on the height of the user, displays the input screen 4 so that the eyes of the user are approximately at the same level with the input screen 4.

The display control unit 161 may also be configured to cancel (delete) the booking information input by the user to the input screen 4 and to notify the user whose user ID is stored in the user ID storage unit 151 that the booking information is cancelled if the user ID comparing unit 162 notifies the display control unit 161 that the user IDs do not match each other.

The user ID comparing unit 162 is a processing unit that compares the user ID received when the user inputs the booking information with the user ID received when the user sets the booking information, and determines whether the user IDs match each other. More specifically, when the display control unit 161 provides the user ID to the user ID comparing unit 162, the user ID comparing unit 162 determines whether the user ID provided by the display control unit 161 matches the user ID stored in the user ID storage unit 151, and notifies the result of the determination (i.e. the result that the IDs match or do not match each other) to the display control unit 161.

The booking processing unit 163 is a processing unit that performs processes regarding booking of an accommodation facility based on the booking information input by the user to the input screen 4. More specifically, the booking processing unit 163 generates booking requesting information to request the booking management server device 10 for the booking according to the booking information provided by the display control unit 161, and transmits the booking requesting information thus generated to the booking management server device 10 via the interface control unit 140. Thus, the processes for booking an accommodation facility are performed in the booking management server device 10.

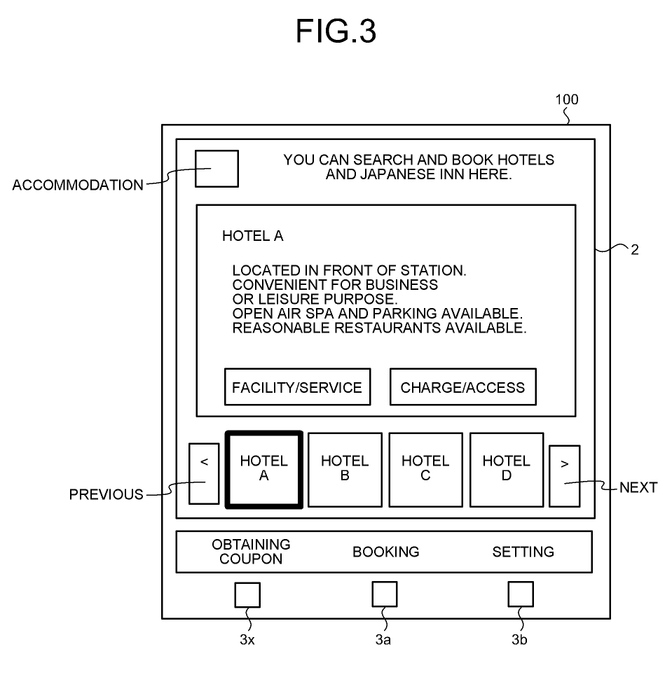

Specific examples of information provided by the information providing apparatus 100 according to the first embodiment are described below in greater detail. FIG. 3 is a schematic of a specific example of information provided by the information providing apparatus 100. In the information providing apparatus 100 depicted in FIG. 3, a list of a plurality of accommodation facilities (a “hotel A”, a “hotel B”, a “hotel C”, and a “hotel D”) is displayed at a lower section of the display 2, which corresponds to the display unit 110 depicted in FIG. 2, and information regarding the “hotel A” selected from the list by the user is displayed at an upper section of the display 2.

The information providing apparatus 100 includes the IC card readers 3a and 3b, which correspond to the card reading units 130a and 130b depicted in FIG. 2 respectively, and an IC card reader 3x. A menu including the items “Obtaining coupon” “Booking”, and “Setting” is displayed on the IC card readers so that the item “Booking” is positioned on the IC card reader 3a, the item “Setting” is positioned on the IC card reader 3b, and the item “Obtaining coupon” is positioned on the IC card reader 3x.

Therefore, if the user puts the IC card 1 over the IC card reader 3a, the processes required for inputting booking information can be performed. If the user puts the IC card 1 over the IC card reader 3b, the processes required for setting the booking information can be performed. If the user puts the IC card 1 over the IC card reader 3x, discounting information can be obtained. The discounting information thus obtained may be associated with the user and transmitted to the booking management server device 10, or may be written into the IC card reader.

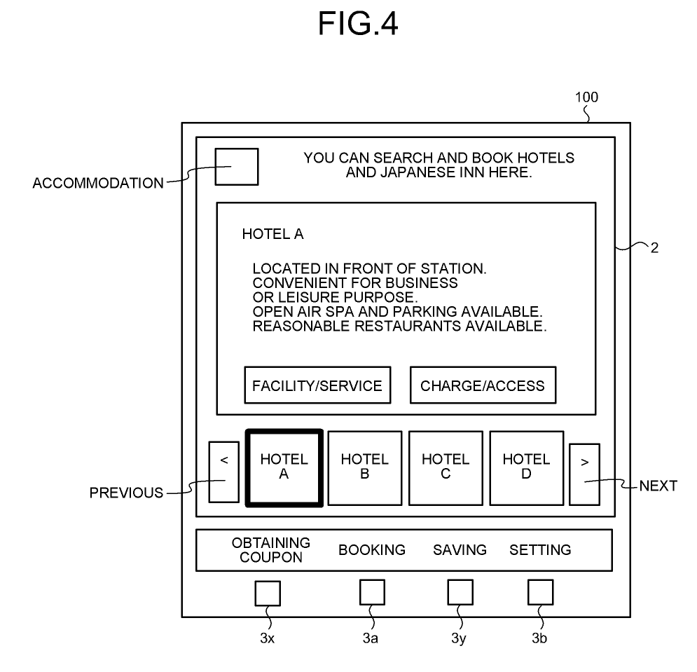

Additional IC card readers may be provided to the information providing apparatus 100. The information providing apparatus 100 may be configured so that the booking information entered halfway through by the user can be saved in the information providing apparatus 100 if the user puts the IC card 1 over the additional IC card reader. FIG. 4 is a schematic of a specific example of information provided by the information providing apparatus 100 that can save booking information. In the information providing apparatus 100 depicted in FIG. 4, an additional IC card reader 3y is provided therewith. An item “Saving” is displayed in the menu so as to be positioned on the IC card reader 3y.

In such a case, the display control unit 161 determines that the item “Saving” is selected from the menu if the user puts the IC card 1 over the IC card reader 3y, and receives the user ID read by the IC card reader 3y. The display control unit 161 provides the user ID thus received to the user ID comparing unit 162 to determine whether the received user ID matches the user ID stored in the user ID storage unit 151.

If the user ID comparing unit 162 notifies the display control unit 161 that the user IDs match each other, the display control unit 161 first associates the booking information displayed on the input screen 4 with the user ID, and then, not only saves the booking information in the storage unit 150, but also hides the input screen 4.

Then, if the user puts the IC card 1 over the IC card reader 3a, the display control unit 161 controls the user ID comparing unit 162 to compare the user ID read by the IC card reader 3a with the user ID stored in the user ID storage unit 151, similar to when the user first inputs the booking information. If the user IDs match each other, the display control unit 161 determines that the user who saved the booking information therein again selected the item “Booking” from the menu. Thus, the display control unit 161 reads the booking information stored therein, sets the booking information in the display 4, and displays the input screen 4 again.

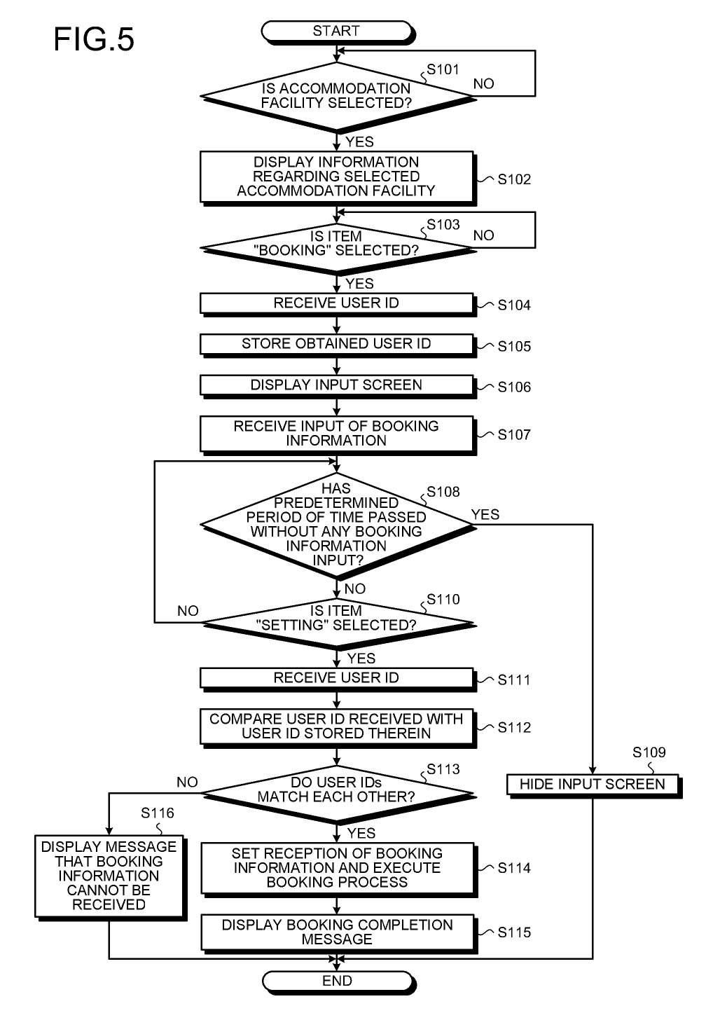

Processing procedures performed by the information providing apparatus 100 according to the first embodiment are described below in greater detail. FIG. 5 is a flowchart of the processing procedures performed by the information providing apparatus 100 according to the first embodiment. In the present example, similar to the specific example depicted in FIG. 3, the display unit 110, the card reading units 130a and 130b depicted in FIG. 2 are described as the display 2, the IC card readers 3a and 3b respectively.

As depicted in FIG. 5, in the information providing apparatus 100, if the user selects an accommodation facility from the list of the hotels (Yes at Step S101) the display control unit 161 obtains information regarding the accommodation facility selected by the user from the booking management server device 10, and displays the information on the display 2 (Step S102).

Then, if the user puts the IC card 1 over the IC card reader 3a, the display control unit 161 determines that the item “Booking” is selected from the menu (Yes at Step S103) receives the user ID read by the IC card reader 3a (Step S104), and stores the user ID in the user ID storage unit 151 (Step S105).

The display control unit 161 displays the input screen 4 on the display 2 (Step S106), and receives input of the booking information (Step S107). If the user does not input any booking information for a predetermined period of time (Yes at Step S108), the display control unit 161 hides the input screen 4 (Step S109).

If the user puts the IC card 1 over the IC card reader 3b after inputting the booking information within the predetermined period of time (No at Step S108), the display control unit 161 determines that the item “Setting” is selected from the menu (Yes at Step S110), and receives the user ID read by the IC card reader 3b (Step S111).

Then, the user ID comparing unit 162 compares the user ID received by the display control unit 161 with the user ID stored in the user ID storage unit 151 (Step S112). If the user IDs match each other (Yes at Step S113), the booking processing unit 163 executes the booking process to request the booking management server device 10 for booking (Step S114), and the display control unit 161 displays a booking completion message on the display 2 (Step S115).

On the other hand, if the user IDs do not match each other (No at Step S113), the display control unit 161 displays on the display 2 a message that the booking information is not received (Step S116).

As described above, in the first embodiment, the display control unit 161 receives the user ID read by the IC card reader 3a (the card reading unit 130a), stores the user ID in the user ID storage unit 151, and receives the user ID read by the IC card reader 3b (the card reading unit 130b) after the user inputs booking information by using the input screen 4 that receives the booking information. The user ID comparing unit 162 determines whether the user ID received by the IC card reader 3b matches the user ID stored in the user ID storage unit 151. If the user ID comparing unit 162 determines that the user IDs match each other, the booking processing unit 163 sets reception of the booking information input by using the input screen 4. Therefore, it can be avoided that some users other than the user who inputs the booking information sets the booking information. As a result, the booking information can be received with easier and more reliable user authentication.

In the first embodiment, when the display control unit 161 first receives the user identification information read by the IC card reader 3a, the display control unit 161 displays the input screen 4. Therefore, the display screen of the display 2 can be more efficiently utilized than in a case in which the input screen 4 is fixedly displayed in the display 2.

In the first embodiment, the display control unit 161 further receives user attribute information read by the IC card reader 3a from the user. The display control unit 161 may be configured to modify the input screen 4 according to the user attribute information thus received from the user. Therefore, the items that the user is required to input can be narrowed down according to the user attribute such as the sex and age of the user, thereby reducing the time required for inputting the booking information.

In the first embodiment, the display control unit 161 further receives the user attribute information read by the IC card reader 3a from the user. The display control unit 161 may be configured to modify the display position of the input screen 4 according to the user attribute information thus received from the user. Therefore, the input screen 4 can be displayed in a position in which the user can easily input the input information according to the user attributes such as the height of the user, thereby reducing the load on the user while inputting the booking information.

In the first embodiment, the display control unit 161 hides the input screen 4 if the user does not input any booking information for a predetermined period of time after displaying the input screen 4. Thus, the input screen 4 can be automatically hidden even if the user stops inputting halfway through for some reasons or other. Therefore, it can be avoided that the input screen 4 is left to be displayed on the display 2.

In the first embodiment, after the user partially inputs the booking information by using the input screen 4, the display control unit 161 receives the user ID read by the IC card reader 3y. The user ID comparing unit 162 determines whether the user ID received by the IC card reader 3y with the user ID stored in the user ID storage unit 151. If the user ID comparing unit 162 determines that the user IDs match each other, the display control unit 161 may save in the storage unit 150 the booking information input in the input screen and hide the input screen 4. If the display control unit 161 receives the user ID read by the IC card reader 3a after saving the booking information in the storage unit 150, the display control unit 161 may see whether the user ID is stored in the user ID storage unit 151. If the user ID is stored therein, the display control unit 161 may display on the display 2 the input screen 4 that is hidden. Thus, even if the user is forced to stop inputting the input information halfway through for some reasons or other, the user can temporarily save the already input booking information in the information providing apparatus and can restart inputting the rest of the booking information later. Therefore, the user can efficiently input booking information.

In the first embodiment, if the user ID comparing unit 162 determines that the user IDs do not match each other, the display control unit 161 may not only cancel the booking information input in the input screen 4, but also notify the user identified by the user ID stored in the user ID storage unit 151 that the booking information is cancelled. Thus, even if the user stops inputting the booking information halfway through, the user can confirm later whether the input information is cancelled. Therefore, the user can be freed from the anxiety of leaving the booking information on the input screen 4.

In the first embodiment, the information providing apparatus 100 is provided with an IC card reader that reads a user ID from an IC chip in which the user ID is stored, and receives the user ID read by the IC card reader. The user can be saved from troubles of inputting the user ID, the password, and the like. Therefore, the user can easily make the information providing apparatus 100 recognize the user ID.

In the first embodiment, the IC chip that stores the user ID therein is a contactless IC chip, and the IC card readers 3a, 3b, and 3y are contactless IC readers. The user can easily make the information providing apparatus 100 recognize the user ID by using a device such as a contactless IC card and a mobile phone in which a contactless IC chip is embedded.

In the first embodiment, if the user does not input any input information for a predetermined period of time, the display unit 161 hides the input screen 4. Then, the input information input in the input screen 4 may be cancelled and the user identified by the user ID stored in the user ID storage unit 151 may be notified that the booking information is cancelled. Thus, even if the user stops inputting the booking information halfway through, the user can confirm later whether the input information is cancelled. Therefore, the user can be freed from the anxiety of leaving the input information on the input screen 4.

In the first embodiment, an example is described in greater detail that the present invention is applied to the information providing apparatus that provides information to the user regarding an accommodation facility and receives a booking of an accommodation facility. The present invention is, however, not limited thereto, and can be similarly applied to an information providing apparatus that is installed in facilities such as train stations to provide train operation information and to enable booking of train seats.

In the first embodiment, an example is described in greater detail that the information providing apparatus is utilized by one user. A plurality of users can, however, simultaneously utilize an information providing apparatus if the information providing apparatus is provided with a plurality of IC card readers.

A second embodiment of the present invention is described below in greater detail. More specifically, in the second embodiment, the present invention is applied to an information providing apparatus that not only provides train operation information, but also enables booking of a train seat, and is simultaneously used by a plurality of users. The information providing apparatus described below in greater detail has similar configuration and processing procedures as the information providing apparatus 100 described in the first embodiment. Thus, in the second embodiment, for convenience of description, description regarding the configuration and the processing procedures are omitted below, and the information providing apparatus according to the second embodiment and an example of an input screen thereof are described below in greater detail.

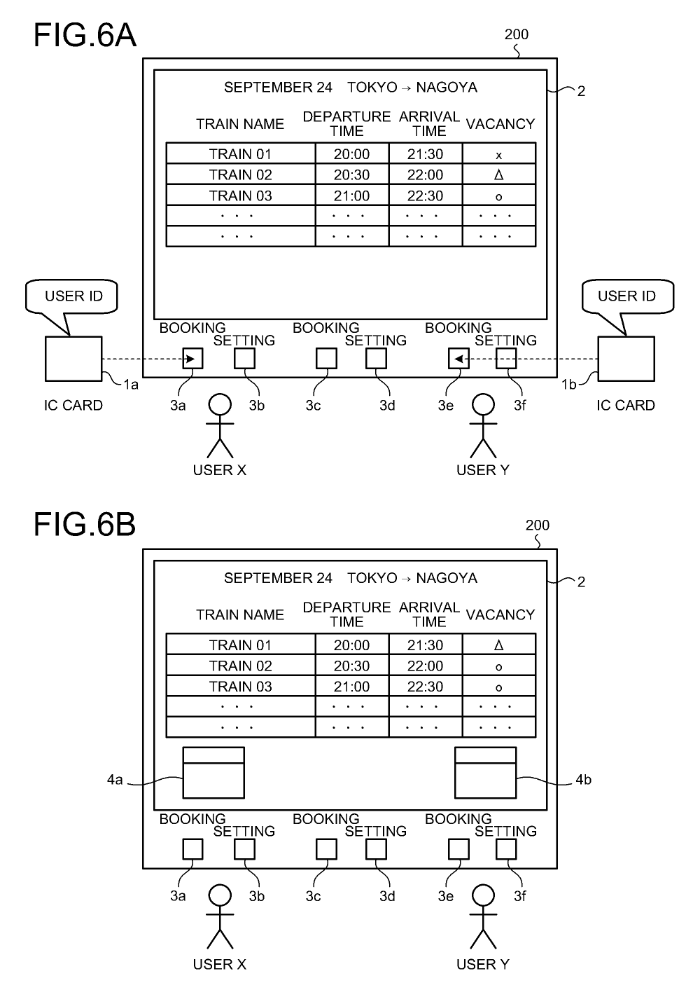

FIGS. 6A and 6B are schematics for explaining the information providing apparatus according to the second embodiment. An information providing apparatus 200 is installed, for example, in train stations, and can not only provide train operation information, but also, be used for booking a train seat.

As depicted in FIGS. 6A and 6B, the information providing apparatus 200 includes the display 2 that displays train operation information and IC card readers 3a, 3b, 3c, 3d, 3e, and 3f that read information regarding each of the users from an IC card in which a contactless IC chip is embedded. Each of the IC cards is owned by each of the users. In each of the IC cards, information such as the user ID that is used for identifying the user is recorded. The information providing apparatus 200 can perform user authentication by reading user IDs with the IC card readers 3a, 3b, 3c, 3d, 3e, and 3f.

A menu including a plurality of sets of “Booking” and “Setting” is displayed at a lower section of the display 2. The items “Booking” are displayed on the IC card readers 3a, 3c, and 3e. The items “Setting” are displayed on the IC card readers 3b, 3d, and 3f. Each user can put the IC card over the IC card reader 3a, 3c, or 3e, and information regarding seat booking is input in the information providing apparatus 200. Each user can put the IC card over the IC card readers 3b, 3d, and 3f, and the information thus input thereby is set.

It is described below in greater detail that the information providing apparatus 200 is used by, for example, users X and Y to book train seats. The display 2 of the information providing apparatus 200 initially displays information such as the names, the departure times, the arrival times, and availabilities of trains in operation of the day. The marks, “x” “Δ”, and “o” indicate “no seats available”, “a few seats available”, and “enough seats available”, respectively.

The user X is informed by the information providing apparatus 200 that a seat is available in a train 02, and puts the IC card 1a that the user X owns over the IC card reader 3a. Then, the information providing apparatus 200 receives the user ID of the user X from the IC card 1a, and stores the user ID in the information providing apparatus 200. At the same time, the user Y is informed thereby that a seat is available in a train 03, and put the IC card 1b that the user Y owns over the IC card reader 3e. Then, the information providing apparatus 200 receives the user ID of the user Y from the IC card 1b, and stores the user ID in the information providing apparatus 200. The information providing apparatus 200 stores therein user IDs of the users X and Y (See FIG. 6A).

The information providing apparatus 200 displays an input screen 4a in a display position that is set near the IC card reader 3a, and an input screen 4b in a display position that is set near the IC card reader 3e. The input screen 4a is used for inputting information required for booking a seat in the train 02, and the input screen 4b is used for inputting information required for booking a seat in the train 03 (See FIG. 6B).

Even if the users X and Y are near, the information providing apparatus 200 selects display positions for the input screens 4a and 4b on the display 2 and displays the input screens 4a and 4b so that the input screens 4a and 4b do not overlap each other.

The user X inputs in the input screen 4a information required for booking a seat (hereinafter, “seat booking information”) for the train 02, and the user Y inputs in the input screen 4b seat booking information for the train 03. Then, the user X puts the IC card 1a over the IC card reader 3b, and the user Y puts the IC card 1b over the IC card reader 3f, thereby setting the seat booking information for the users X and Y. Setting seat booking information is described below in greater detail by illustrating an input screen.

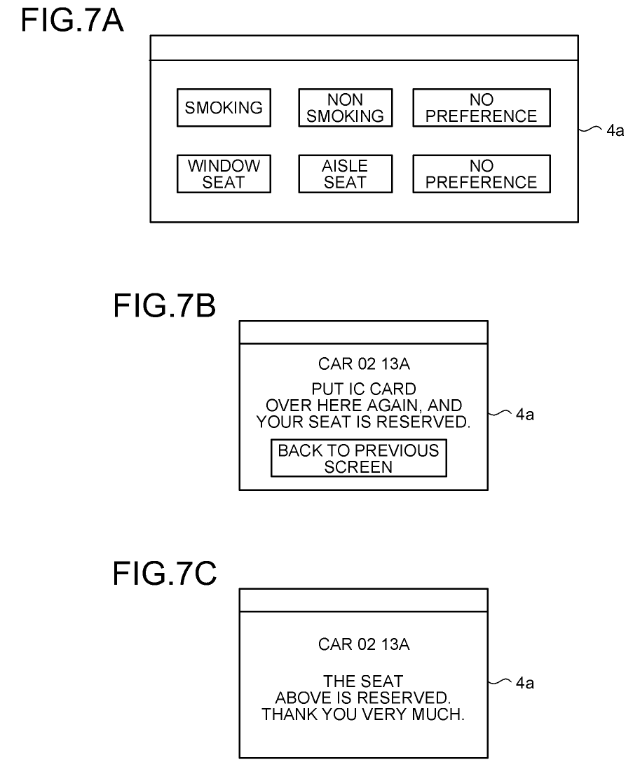

The input screens 4a and 4b differ in display format according to train type such as the number of seats therein. In the present embodiment, however, an example thereof is described as the input screen 4a displayed by the user X. FIGS. 7A, 7B, and 7c are schematics of examples of the input screen 4a according to the second embodiment.

As depicted in FIG. 7A, for example, the items for selecting a car type (“smoking car”, “non smoking car”, and “no preference”), the items for selecting a seat position (“window seat”, “aisle seat”, and “no preference”), and the like are displayed on the input screen 4a. Each user selects preferable one from each of the items (See FIG. 7A).

When the user X selects desirable one from each of the items, the information providing apparatus 200 makes an inquiry to a device such as a seat booking management server device connected to the information providing apparatus 200 via a network. Thus, the information providing apparatus 200 selects a seat that matches the demand of the use X, and displays the seat on the input screen 4a (See FIG. 7B).

When the user X puts the IC card 1a that the user X owns over the IC card reader 3b, the information providing apparatus 200 receives the user ID of the user X and searches the user ID stored in the user ID storage unit 151 for the user ID received via the IC card reader 3b, thereby determining if the user ID is found in the stored user IDs. If the user ID is found, the information providing apparatus 200 sets reception of the seat booking information that is input in the input screen 4a, and displays on the input screen 4a a message that the seat is reserved (See FIG. 7C).

As described above, in the second embodiment, the IC card readers 3a to 3f are installed in a plurality of predetermined installation positions, and these display positions are set on the display 2. When the display control unit 161 receives a user ID read by the IC card reader 3a, 3c, or 3e, the display control unit 161 selects from the predetermined display positions the display position that is the closest from the IC card reader that reads the user ID, and displays the input screen at the display position. Thus, even if multiple users use the information providing apparatus 200 simultaneously, the input screen for each user can be displayed in a position in which the user can have a good view of the input screen. Therefore, the user can easily input the seat booking information.

In the second embodiment, when the display control unit 161 receives a user ID, the display control unit 161 selects from the display positions the display position that does not overlap the other input screens displayed on the display 2, and displays the input screen at the selected display position. Therefore, even if multiple users simultaneously use the information providing apparatus 200, the users can input the seat booking information at the same time.

In the embodiments, it is described in greater detail that each of the users owns one IC card and each user can perform a series of the procedures (i.e. procedures from inputting booking information to setting the booking information) by using the IC card. For example, a plurality of users may, however, be categorized into a user group, and user IDs are considered to match each other as long as a user who owns an IC card on which one of the user IDs is stored belongs to the same user group. Whereby, entry and setting of booking information can be shared among family members belonging to the same group or company staff members in the same group.

In the embodiments, it is described in greater detail that user authentication is performed by using a user ID recorded on an IC chip. User authentication may also be performed by using biometric information such as a face, a fingerprint, and an amphiblestrode of the user. Thus, the user is not required to carry the IC card, thereby making user authentication easier and more reliable.

In the embodiments, it is described in greater detail that the present invention is applied to the information providing apparatus to book an accommodation facility and a train seat. The present invention is, however, not limited thereto. The present invention may also be applied similarly to, for example, an information providing apparatus installed in an air terminal to book a flight, or an information providing apparatus to book a table of a restaurant, and the like.

In the information providing apparatus described in the embodiments, the functions performed by the processing units (i.e. the display control unit 161, the user ID comparing unit 162, and the booking processing unit 163) may also be implemented by computer software. Thus, an input information receiving program having the identical functions can be obtained. A computer that executes the input information receiving program is described below in greater detail.

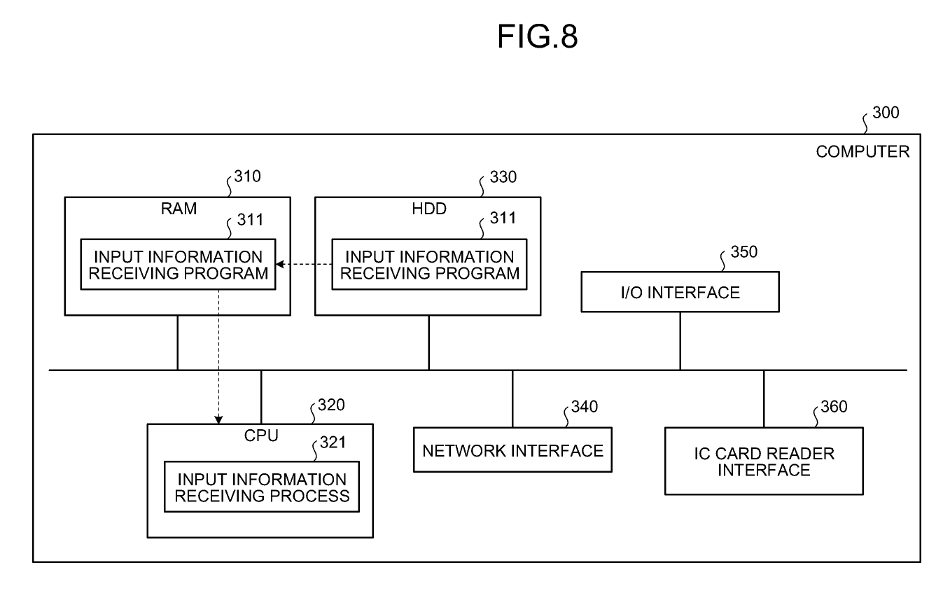

FIG. 8 is a functional block diagram of the computer that executes the input information receiving program. As depicted in FIG. 8, a computer 300 includes a random access memory (RAM) 310, a central processing unit (CPU) 320, a hard disk drive (HDD) 330, a network interface 340, an I/O (Input/Output) interface 350, and IC card reader interface 360.

The RAM 310 is a memory that stores therein a computer program, an execution intermediate result of the computer program, data required for executing the computer program (for example, data stored in the user ID storage unit 151) and the like. The CPU 320 is a central processing unit that reads the computer program from the RAM 310 and executes the computer program.

The HDD 330 is a disk device that stores the computer program and the data therein. The network interface 340 is an interface that connects the computer 300 to other computers (such as the booking management server device 10) and the like via a network.

The I/O interface 350 is an interface that connects a display device (i.e. the display unit 110 and the like) and a input device such as a touch panel (i.e. the input unit 120 and the like) to the computer 300. The IC card reader interface 360 is an interface that connects an IC card reader (i.e. the card reading unit 130a and 130b and the like) to the computer 300.

An input information receiving program 311 executed by the computer 300 is installed in the computer 300 in advance. Alternatively, the input information receiving program 311 is stored in a database of some other computer system connected via the network interface 340 to the computer 300, read from the database, and installed in the computer 300.

The input information receiving program 311 that is thus installed in the computer 300 is stored in the HDD 330, read by the RAM 310, and executed by the CPU 320 as an input information receiving process 321.

Among the procedures described in the embodiments, all or some of the processes that are described to be executed automatically may also be executed manually. On the other hand, all or some of the processes that are described to be executed manually may also be executed automatically by using a known method.

Further, processing procedures, control procedures, specific names, information including various data and parameters that are included in the description above or in the drawings may be arbitrarily modified unless otherwise indicated.

Respective configuration elements of the respective illustrated devices depicted in the drawings are functionally conceptual and are not always physically configured as illustrated. Specifically, a specific pattern into which the devices are dispersed or integrated is not limited to the illustrated pattern. The devices may be configured by functionally or physically dispersing or integrating all or some of the devices arbitrary in accordance with various loads or usages.

All or some of the processing functions performed by the devices may be implemented by a CPU or a computer program that is analyzed and executed by the CPU, or by a wired-logic hardware.

According to the embodiments, a user other than the user who has input the input information cannot set the input information, and thus, the embodiments provide a benefit that the input information can be received with easy and reliable user authentication.

The embodiments provide a benefit that a display screen of a display device can be utilized more efficiently than in a case in which the input screen is fixedly displayed in the display device.

According to the embodiments, items that the user is required to fill out can be narrowed down based on user attribution such as sex and age. Therefore, the embodiments provide a benefit that less time can be spent for inputting the input information.

According to the embodiments, an input screen can be displayed in a position in which the user can easily input the input information based on user attributes such as the height of the user. Therefore, the embodiments provide a benefit that the load on the user while inputting the input information can be reduced.

According to the embodiments, the input screen can be hidden. Thus, the input screen can be automatically hidden even if the user stops inputting the input information halfway through for some reasons or other. Therefore, the embodiments provide a benefit that it can be avoided that the input screen is left to be displayed on the display device.

According to the embodiments, even if the user is forced to stop inputting the input information halfway through for some reasons or other, the user can temporarily save the input information in the information providing apparatus and can restart inputting the rest of the input information later. Therefore, the embodiments provide a benefit that the user can input the input information efficiently.

According to the embodiments, even if the user stopped inputting the input information halfway through, the user can confirm later whether the input information is cancelled. Therefore, the embodiments provide a benefit that the user can be freed from the anxiety of leaving the input information on the input screen.

According to the embodiments, the user can bee saved from the troubles of inputting the user ID and password. Therefore, the embodiments provide a benefit that the user can easily provide the user identification information to the information providing apparatus to make the information providing apparatus recognize the user identification information.

According to the embodiments, even if a plurality of users use the information providing apparatus simultaneously, input screens for each of the users can be displayed in a position where each user can have a good view of the input screen. Therefore, the embodiments provide a benefit that the users can easily input the input information.

The embodiments provide a benefit that even if a plurality of users use the information providing apparatus simultaneously, the users can input the input information at the same time.

The embodiments provide a benefit that the user can easily provide the user identification information to the information providing apparatus by using a contactless IC card or a mobile phone in which a contactless IC chip is embedded to make the information providing apparatus recognize the user identification information.

According to the embodiments, even if the user stops inputting the input information halfway through, the user can confirm later whether the input information is cancelled. Therefore, the embodiments provide a benefit that the user can be freed from the anxiety of leaving the input information on the input screen.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An information providing apparatus comprising:
a display control unit that receives 1st user identification information and stores the 1st user identification information in a storage unit, receives input information input to an input screen of a display, and receives 2nd user identification information;
a user identification information comparing unit that determines whether the 2nd user identification information matches the 1st user identification information stored in the storage unit; and
a user information setting unit that confirms reception of the input information if the user identification information comparing unit determines that the 2nd user identification information matches the 1st user identification information.

2. The information providing apparatus according to claim 1, wherein the display control unit further displays the input screen after receiving the 1st user identification information to the display.

3. The information providing apparatus according to claim 1, wherein
the display control unit further receives user attribute information with the 1st identification information, and displays the input screen to a display device according to the user attribute information.

4. The information providing apparatus according to claim 3, wherein
the display control unit displays the input screen to the display device at predetermined display position according to the user attribute information.

5. The information providing apparatus according to claim 2, wherein
the display control unit hides the input screen if a predetermined period passed without receiving input to the input screen.

6. The information providing apparatus according to claim 2, wherein
the display control unit further saves the input information that is input to the input screen, hides the input screen if the user identification information provisional comparing unit determines that the 2nd user identification information matches the 1st user identification information, receives 3rd user identification information, and re-displays the hidden input screen if the received 3rd user identification information is stored in the storage unit.

7. The information providing apparatus according to claim 1, wherein the display control unit further cancels the input information if the user identification information comparing unit determines that the 2nd user identification information does not match the 1st user identification information, and displays an information notifying that the input information is cancelled to the display.

8. The information providing apparatus according to claim 1, further comprising:
at least one user identification information reading unit that reads the user identification information from a storage medium in which the user identification information is stored, wherein
the display control unit receives the 1st and 2nd user identification informations read by the user identification information reading unit.

9. The information providing apparatus according to claim 8, wherein
each of the user identification information reading unit is installed in predetermined installation positions, and
the display control unit selects, from a plurality of predetermined display positions, a display position that is closest to an installation position of the user identification information reading unit that reads the user identification information and displays the input screen at the selected display position.

10. The information providing apparatus according to claim 8, wherein
each of the user identification information reading unit is installed in predetermined installation positions, and
the display control unit selects, from a plurality of predetermined display positions, a display position that does not overlap other input screens displayed on the display device and displays the input screen at the selected display position to the display.

11. The information providing apparatus according to claim 8, wherein the storage medium is a contactless IC chip and the user identification information reading unit is a contactless IC reader.

12. The information providing apparatus according to claim 5, wherein the display control unit further cancels the input information if the predetermined period passed without receiving input to the input screen, and displays an information notifying that the input information is cancelled to the display.

13. An information receiving method comprising:
1st receiving user identification information;
storing the 1st received user identification information to a storage device;
receiving input information to an input screen of a display device;
2nd receiving user identification information after receiving the input information; and
confirming reception of the input information if the 2nd received user identification information matches the stored 1st received user identification information.

14. The information receiving method according to claim 13, further comprising displaying the input screen to the display device if the 1st user identification information is received.

15. The information receiving method according to claim 14, further comprising:
receiving user attribute information; and
modifying the input screen according to the received user attribute information wherein
the displaying displays the modified input screen to the display device.

16. The information receiving method according to claim 13, further comprising:
1st reading the user identification information stored in a storage medium; and
2nd reading the user identification information stored in a storage medium after receiving the input information; wherein
the 1st receiving receives the 1st red user identification information, and
the 2nd receiving receives the 2nd red user identification information.

17. A computer readable storage medium that stores therein a computer program causing a computer to perform a process comprising:
1st receiving user identification information;
storing the 1st received user identification information to a storage device;
receiving input information to an input screen of a display device;
2nd receiving user identification information after receiving the input information; and
confirming reception of the input information if the 2nd user identification information matches the stored 1st received user identification information.

18. The computer readable storage medium according to claim 17, further comprising displaying the input screen if the user identification information is received.

19. The computer readable storage medium according to claim 18, further comprising:
receiving user attribute information; and
modifying the input screen according to the user attribute information wherein
the displaying displays the modified input screen to the display device.

20. The computer readable storage medium according to claim 17, further comprising:
1st reading the user identification information stored in a storage medium; and
2nd reading the user identification information stored in a storage medium after receiving the input information, wherein
the 1st receiving receives the 1st red user identification information, and
the 2nd receiving receives the 2nd red user identification information.
